(19) United States
(12) Patent Application Publication
(10) Pub. No.: US 2010/0088745 A1
(43) Pub. Date: Apr. 8, 2010

(54) METHOD FOR CHECKING THE INTEGRITY OF LARGE DATA ITEMS RAPIDLY

(75) Inventors: Zhexuan SONG, Silver Spring, MD (US); Jesus Molina, Washington, DC (US)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/246,144

(22) Filed: Oct. 6, 2008

(51) Int. Cl. H04L 9/32; G06F 9/455

(52) U.S. Cl. 726/2; 718/1

(57) ABSTRACT

The embodiments read, by a computer, target data and divide the target data into chunks. Initial digest values for each chunk of the target data are maintained. Digest values for a subset of the chunks, based upon the target data, is obtained. And a computer compares the obtained subset of digest values of the target data with corresponding subset of maintained initial digest values and verifies integrity of the target data according to the comparison.

### BACKGROUND

1. Field

The embodiments discussed herein relate to data integrity verification.

2. Description of the Related Art

Currently, for example, in order to check whether a file stored on a hard disk drive at a computer has been modified from its initial value, a widely used mechanism is to load the whole file from the disk and calculate a digest value of the whole file based on a hash-function (e.g. MD5 or SHA1) of the file or data block. The calculated digest value is then compared with the original digest value. If both original and subsequent digest values of the whole file do not match, it is determined that the whole file must have been modified. Otherwise, since the possibility of a collision of digest value is very low and the digest calculation function is an one-way function, if both digest values match, it is safe to believe that the whole file is not modified.

However, for a large file, it takes a very long period of time to calculate the digest value (sometimes several minutes or longer). The main bottleneck is typically the disk I/O time (99.9% of time for an operation is in reading data from disks).

### SUMMARY

It is an aspect of the embodiments discussed herein to provide a method, including apparatus/machine (computer) and computer readable media thereof, of verifying integrity of data. According to an aspect of an embodiment, the embodiments substantially increase the speed of or substantially reduce the time for verifying integrity of a large file or data block.

The embodiments provide a method, computer readable medium and apparatus thereof, of reading, by a computer, target data and dividing target data into chunks, maintaining initial digest values for each data chunk of the target data, obtaining digest values for a subset of the chunks, based upon the target data, computer comparing the obtained subset of digest values of the target data with corresponding subset of maintained initial digest values, and verifying integrity of the target data according to the comparing.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram of a computer system embodying the embodiments of the invention.

FIG. 2 is a flow chart of verifying integrity of stored data, according to an embodiment of the invention.

FIG. 3 is a diagram of another computer system embodying the embodiments of the invention.

FIG. 4 is a functional block diagram of a computer for the embodiments of the invention.

### DETAILED DESCRIPTION OF THE EMBODIMENTS

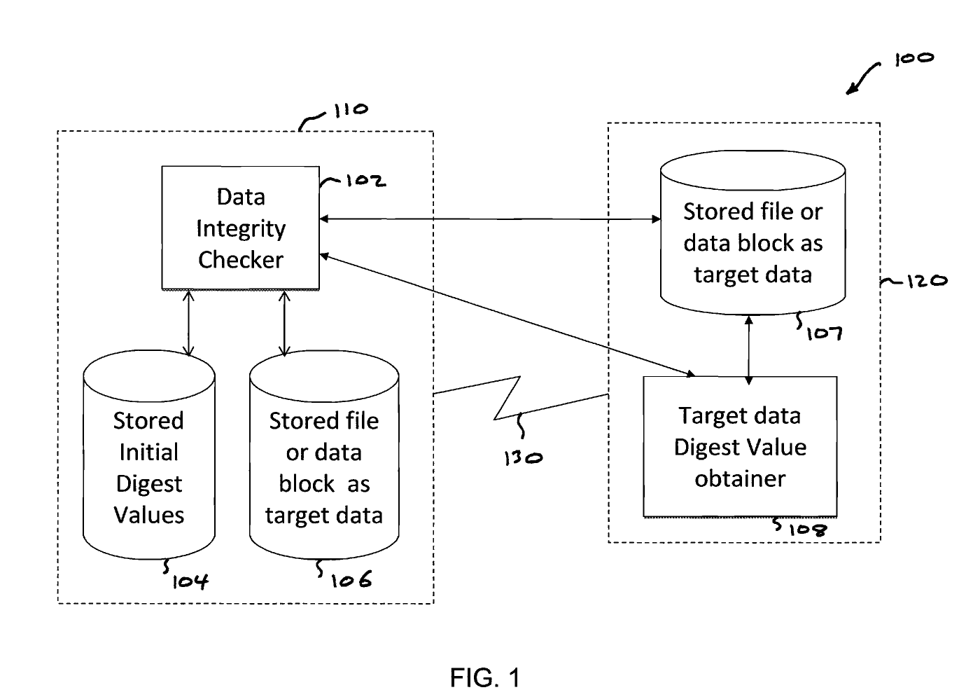

FIG. 1 is a diagram of a computer system embodying the embodiments, according to an aspect of the invention. In FIG. 1, a computer system 100 includes a data integrity checker 102 managing, for example, calculating, initial digest values of chunks of a whole file or data block as target data 106 and checking or verifying integrity of the target data 106 based upon the initial digest values. A digest value database 104 stores the initial digest values corresponding to the file or data block as the target data 106. Target data 106 can be any computer readable information in any format (compressed, not compressed, transformed (encrypted), etc.), such as (without limitation) virtual machine image, multimedia data, such as audio and/or video, images recorded on computer readable recording media, such as DVD, CD, etc. According to an aspect of an embodiment the data integrity checker 102 may reside in a module within the same device and/or in client-server architecture, reside in a remote device as a server in communication over a network with a client device. For example, in FIG. 1, the data integrity checker 102 is software application in a server 110 checking integrity of target data 107 stored in computer readable recording medium of a client device 120. A target data digest value manager 108 cooperates or interfaces with the data integrity checker 102 and manages, for example, calculates, digest values based upon the target data 107 stored in the client 120. The server 110 and client device 120 are in wire and/or wireless network 130 communication. According to an aspect of an embodiment, a digest value or hash value is any transformation that takes an input and returns or outputs a string, for example, fixed size string. The transformation can be based upon any hash function (e.g., MD5, SHA1, etc.).

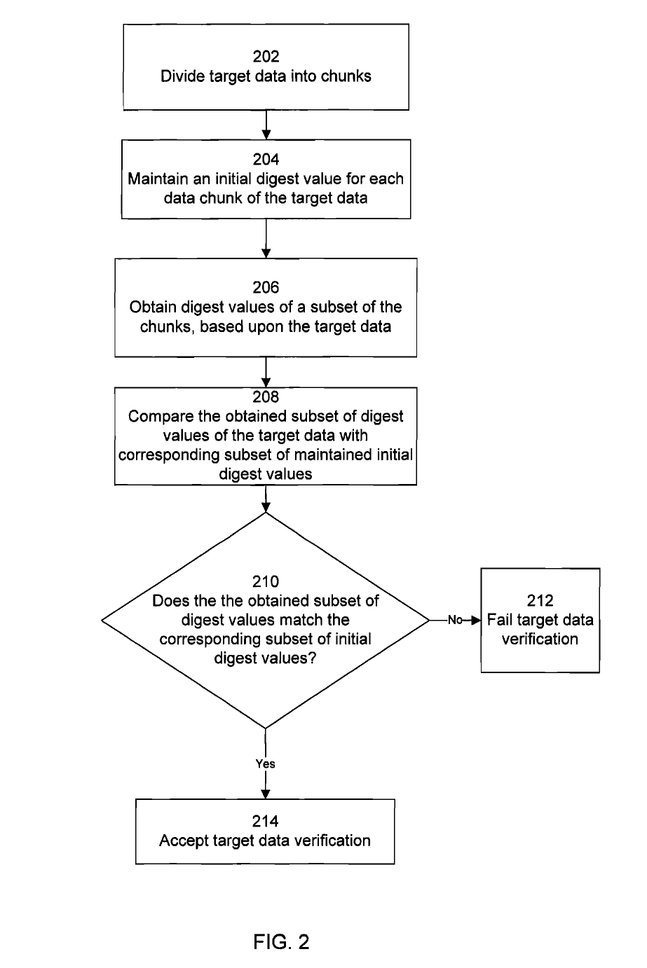

FIG. 2 is a flow chart of verifying integrity of stored data, according to an embodiment. Operation 202 provides dividing target data into chunks. Chunk refers to any length of read data. According to an aspect of an embodiment, when operating system supports a random read of a file, i.e. a program can jump to any point of a file and read any length of data out of the file from that point, the embodiments use an operating system random read, jump to several places according to selection criteria, and read the selected chunks. Then calculate the hash value of the selected chunks. However, the embodiments are not limited to operating system random read function or service, but the embodiments treat a whole computer file as one data block and read selected chunks of the one data block. For example, at operation 202, the initial file or data block as target data 106 (107) is divided into n fixed-size chunks (e.g. 1 MByte each), labeled 0, . . . , n-1. A chunk identifier can be assigned to each data chunk, so given a chunk ID i, the start position of the chunk within the target data is i*chunk_size, and the end position of the chunk is (i+1)*chunk_size −1. A benefit of the embodiments is that only chunk_size*chunk_ID_size bytes of data is read instead of the full file or data block, thus reducing time of data verification. However, the embodiments are not limited to a fixed chunk size, and variable chunk sizes can be provided.

Operation 204 provides maintaining an initial digest value for each chunk of the target data. For example, at operation 204, at the checker side 102, a digest value of each chunk is pre-calculated and stored for verification as stored initial digest values 104. According to an aspect of an embodiment, the file or data block is delivered or transmitted to client(s) 120 and stored as target data 107 on the client side disk.

Operation 206 provides obtaining digest values for a subset of the chunks, based upon the target data 106 (107). For example, the obtaining of the subset of digest values includes calculating digest values for selected chunks of the target data. For example, the obtaining of the subset of digest values comprises determining a chunk list based upon selecting the chunks and/or a number of the selected chunks of the target data and obtaining the digest values of the chunk list as the subset of digest values. For example, the chunk list is a predetermined list and/or a generated list of chunks of the target data. For example, the selection of chunks and/or the number of selected chunks is controlled randomly and/or based upon one or more parameters dynamically and/or in real-time. For example, the parameter is a data area or chunk modifiability characteristic of the target data, chunk size, random (e.g., random chunk selection and/or random number of chunks), verification time (e.g., variable periodic verification of target data, chunk selection and/or number of chunks), and/or user defined. Regarding time parameter, any of the other parameters can be varied as a function of time (e.g., time of day, day, year, etc.).

According to an aspect of an embodiment, when it is time to check the integrity of the target file or data block 107 at a client 120, the checker 102 at the server 110 first provides a list of chunk IDs to the target data digest value obtainer 108 at the client 120. Typically, this list is a subset of the entire chunk ID list. Then the target data digest value obtainer 108 at the client 120, obtains, for example, calculates, the digest value of selected chunks using the chunk IDs from the list provided from the checker 102 at the server 110. According to an aspect of an embodiment, the obtained chunk digest values corresponding to the list of chunk IDs is then put together into a new data block as concatenated target digest value, and a digest value of the concatenated digest value is calculated. The final result is then sent to the checker 102.

Operation 208 provides comparing the obtained subset of digest values of the target data 106 (107) with corresponding subset of maintained initial digest values. Operation 210 determines whether the corresponding subset of initial digest values match the obtained subset of digest values. For example, at operation 208, the checker 102 does a calculation based upon initial digest values similar to calculation of the concatenated digest value based upon the target data 106 or 107. The checker 102 picks the pre-calculated or initial chunk digest values of the given chunk ID list, puts them together in one data block as an concatenated initial digest value and calculates the digest value of the concatenated initial digest value. The checker 102 then compares the concatenated initial digest value with the concatenated target digest value, for example, from the client 120. If, at operation 210, both results do not match, the file or data block, for example, at the client side 120 must have been modified, so at operation 212, the target data 107 integrity verification fails. If at operation 210, the results match, the file or data block at the client side 120 is very likely unchanged, so at operation 214, the target data 107 verification is acceptable or successful. While the possibility of a false-accept (i.e. the file or data block is modified, but the check result shows unmodified) is higher than the possibility that results from calculating the digest value for the complete file or data block, however, the embodiments decrease the possibility of false-accepts as discussed herein.

According to an aspect of an embodiment, the obtaining of the subset of digest values by determining a chunk list based upon selecting the chunks and/or a number of the selected chunks of the target data and obtaining the digest values of the chunk list as the subset of digest values. The selection of the chunks and/or the number of chunks is controllable randomly and/or based upon parameters, providing a benefit of reducing false accepts or increasing accuracy of the data integrity verification. Further, the chunk list is dynamically and/or real-time controllable. According to an aspect of an embodiment, at operation 206, an alternative method of selecting chunks for digest value calculation, is to pre-define a pseudo-random number generator, for example, for the client 120. First the client 120 uses a seed, for example, a current timestamp as the seed, for the generator and generates a list of chunk IDs. The size of the list can be pre-defined or dynamically and/or real-time determined. After obtaining, for example, calculating digest values of the chunk IDs in the generated list, the client 120 sends a result and the timestamp to the checker 102 and the checker 102 will use the same seed (e.g., timestamp) and a pseudo-random number generator to generate the same chunk list and do the verification. This alternative method does not need the initial chunk ID list from the checker 102, providing a benefit of a single communication loop between the data integrity checker 102 and the target data digest value obtainer 108.

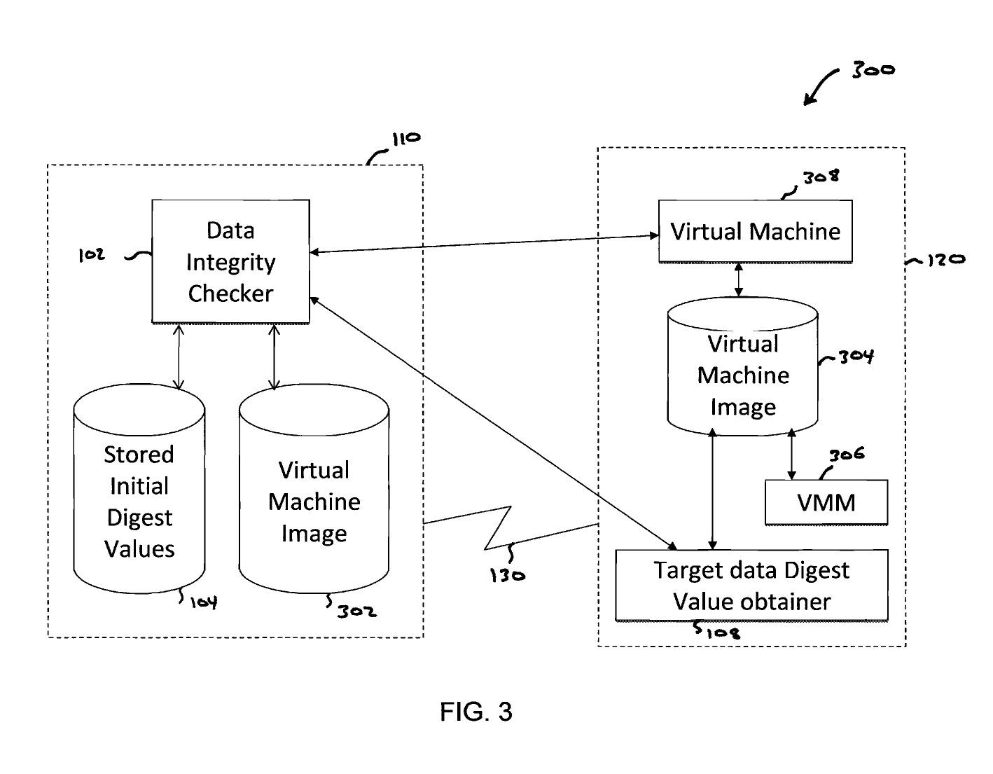

FIG. 3 is a diagram of another computer system embodying the embodiments of the invention. In FIG. 3, the computer system 300 includes a server 110 and a client 120. A virtual machine image (VMI) 302 (304) is used as an example target data 106 (107) respectively. The client 120 includes a virtual machine manager (VMM) 306 executing or launching a VMI 304 as a virtual machine 306. According to an aspect of an embodiment, at operations 202 and 204, at the server 110, the data integrity checker 102 divides the VMI 302 into chunks and maintains initial digest values of the chunks. Then, the server 110 can provide or transmit the VMI 302 to the client 120. At client 120, before VMM 306 releases (or launches) the VMI 304, the data integrity checker 102 in cooperation with the target data digest value obtainer 108 checks or verifies integrity of the VMI 304. Under some circumstances, such as for a virtual machine image (VMI) 304 as the target data 107, certain parts of the VMI 304 are more likely to be modified than the rest or other parts during execution. In order to lower the false-accept error, the checker 102 can pick more chunks at those frequently modified parts of the VMI 304 to detect any changes than from the rest of the VMI 304. For example, chunk selection according to likelihood of unauthorized modification can be done without inspecting the contents of the file by using metrics based on entropy. According to an aspect of an embodiment, the VMI 302 or 304 are read-only. There are several ways to achieve this read-only feature, 1) certain VMMs support this read-only function by restoring the VMI images back to initial state after turning off the VMM 306, 2) controlled via the file system by, for example, before launching the VMI, creating a snapshot of the VMI 304, and after turning off the VMM 306, restore to the snapshot.

According to an aspect of an embodiment, when the target data is a virtual machine image (VMI), one or more data area modifiability characteristics controlling selection and/or number of chunks includes secured or protected data areas (e.g., operating system area), virus targeted data areas, user prohibited data areas, fixed data areas, data area activity metric, or any combinations thereof of the target data. However, the data area modifiability characteristics are not limited to VMIs, and can be applied for any target data 106 (107) as the case may be. For example, verification of virus targeted data areas can be controlled in relation to timing of virus attacks.

The size of and/or the number of chunks can be dynamically and/or real-time controllable based upon testing of computing environment, application criteria (e.g., security level) and/or user defined, for example, determined based upon time that a user is willing to wait for the verification. For example, if the expected time limit is 10 seconds and reading each chunk takes 100 ms, then the size of the chunk ID list should not exceed 100. The checker 110 may determine the size by obtaining the required information from the client before verification. Generally, the more chunks that are picked during verification, the lower the possibility for false-accept results, but the longer the waiting time for the verification. If the place of modification on the file is uniformly distributed, the possibility of false-accept is (1−chunk_ID_list/total_chunks). If there are N chunks that have been modified, the possibility of being detected will be 1−(1-size_of_chunk_ID_list/number_of_total_chunks)̂N. According to an aspect of an embodiments, the false-accept rate is controllable according chunk size, number of chunks, chunk selection parameter, user defined (e.g., user can specify false-accept tolerance, matching tolerance at operation 210), or any combinations thereof.

According to an aspect of an embodiment, one way to lower the false-accept rate is to do a periodical check on the target data 106 (107). Further, the timing of the periodic checks can be varied. Further, every time, a new chunk_ID_list can be randomly selected, so the probability of missing a modification decreases over time.

This invention provides a method to check the consistency of a file or data block in a time-flexible way. If the expected checking time is not limited, this method is equivalent to the full file/data block digest value verification. If the checking time needs to be less than a maximum limit, this method will decrease the amount of data read from the disk, thus reducing and controlling the total verification time. The tradeoff is that the possibility of false-accept increases. A benefit of the embodiments is for use in connection with time-limited applications or in general applications where the size of files or data blocks becomes very large. For example, the embodiments can be used in virtual machine based trusted computing to check the consistency of a large VM disk images, in a non-limiting example, (>10 GByte) and VM memory images, in a non-limiting example, (>1 GByte). The embodiments can also be used to check the integrity of a data CD if the CD is treated as one ISO data block. Further, the embodiments provide a benefit of verifying data integrity before transmitting data, stored data and/or before executing a file (e.g., in case of VMI 302, 304).

According to an aspect of an embodiment, by selectively reading chunks of target data and verifying integrity of the target data, at operation 212, upon verification failure, any troubleshooting, for example, virus attack troubleshooting, application debugging, can be directed to selected area(s) or selected chunks of the target data for which the digest values did not match the initial digest values. According to an aspect of an embodiment, at operation 212 and/or 214, a chunk related parameter can be adjusted according to application criteria, user defined, and/or other parameters.

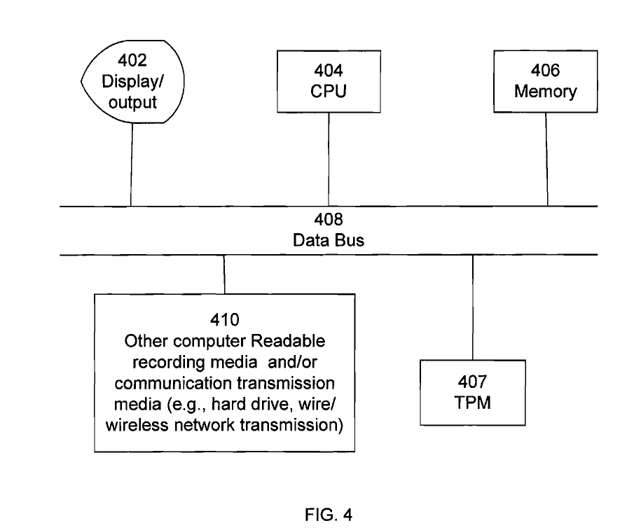

Any combinations of the described features, functions and/or operations can be provided. The embodiments can be implemented in computing hardware (computing apparatus) and/or software, such as (in a non-limiting example) any computer that can store, retrieve, process and/or output data and/or communicate with other computers. FIG. 4 is a functional block diagram of a computer for the embodiments of the invention. In FIG. 4, the computer can be any computing device. Typically, the computer includes a display or output unit 402 to display a user interface or output information or indications, such as a diode. A computer controller 404 (e.g., a hardware central processing unit) executes instructions (e.g., a computer program or software) that control the apparatus to perform operations. Typically, a memory 406 stores the instructions for execution by the controller 404. A Trusted Platform Module 407 can be provided. According to an aspect of an embodiment, the apparatus reads/processes any computer readable recording media and/or communication transmission media 410. The display 402, the CPU 404, the memory 406 and the computer readable media 410 are in communication by the data bus 408. Any results produced can be displayed on a display of the computing hardware.

A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

The embodiments provide a computer system comprising a server computer in communication with a client computer, wherein the client computer comprises a computer controller executing selecting data chunks of target data and obtaining digest values of the selected data chunks, based upon the target data, and wherein the server computer comprises a computer controller executing comparing the digest values of the selected data chunks with corresponding maintained initial digest values of the target data, and verifying integrity of the target data according to the comparing. The selecting of the data chunks is based upon one or more chunk selection parameters including data chunk size, number of data chunks, verification timing, data chunk modifiability characteristic, user defined, security information (e.g. security level of user, target data and/or computing environment (e.g., TPM 407 availability, protectability of selected chunk list), or any combinations thereof. Any of the chunk selection parameters can be provided or determined according testing (e.g., testing of computing environment), application criteria (e.g., security level) and/or user defined.

The target data can be a virtual machine image, and the data chunk modifiability characteristic includes secured data areas, virus targeted data areas, user prohibited data areas, fixed data areas, data area activity metric, or any combinations thereof of the target data. The computer server controller further executes dividing the target data stored on computer readable recording medium into chunks, maintaining the initial digest values for each divided data chunk of the target data, transmitting the target data to the client computer, and selecting data chunks for which digest values are to be obtained and transmitting a list of selected data chunks to the client computer. The client computer obtains the digest values of the data chunks of the target data stored in the client computer, based upon the list of selected data chunks. According to an aspect of an embodiment, once the initial digest values of the chunks of the target data are obtained and maintained, for example, stored, the target data 106, 302 can be removed/deleted until a new updated target data is available subject to integrity verification. The list of selected data chunks can be protected by the TPM 407.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method, comprising:
reading, by a computer, target data and dividing the target data into chunks;
maintaining initial digest values for each chunk of the target data;
obtaining digest values for a subset of the chunks, based upon the target data;
computer comparing the obtained subset of digest values of the target data with corresponding subset of maintained initial digest values; and
verifying integrity of the target data according to the comparing.

2. The method according to claim 1, wherein the obtaining of the subset of digest values comprises calculating digest values for selected chunks of the target data.

3. The method according to claim 1, wherein the obtaining of the subset of digest values comprises determining a chunk list based upon selecting the chunks and/or a number of the selected chunks of the target data and obtaining the digest values of the chunk list as the subset of digest values.

4. The method according to claim 3, wherein the chunk list is a predetermined list and/or a generated list of chunks of the target data.

5. The method according to claim 3, wherein the selection of chunks and/or the number of selected chunks is controlled randomly and/or based upon one or more parameters.

6. The method according to claim 5, wherein the parameter is adjustable automatically and/or user defined and includes one or more of chunk modifiability characteristic, chunk size, number of chunks, verification timing, or any combinations thereof.

7. The method according to claim 6, wherein the target data is a virtual machine image, and chunk modifiability characteristic includes secured data areas, virus targeted data areas, user prohibited data areas, fixed data areas, data area activity metric, or any combinations thereof of the target data.

8. The method according to claim 1, further comprising controlling a false-accept rate of the verifying according to one or more user defined and/or automatically determined adjustable chunk selection parameters including chunk size, number of chunks, verification timing, chunk modifiability characteristic, security information, user defined, or any combinations thereof.

9. An apparatus in communication with a computer readable recording medium, comprising:
a computer controller executing
dividing target data stored on the computer readable recording medium into chunks and maintaining initial digest values for each chunk of the target data;
subsequently selecting chunks of the target data and obtaining digest values of the selected chunks, based upon the target data;
comparing the digest values of the selected chunks with corresponding maintained initial digest values of the target data; and
verifying integrity of the target data according to the comparing.

10. The apparatus according to claim 9, wherein the selecting of the chunks is based upon one or more selection parameters including chunk size, number of chunks, verification timing, chunk modifiability characteristic, security information, user defined, or any combinations thereof.

11. The apparatus according to claim 10, wherein the target data is a virtual machine image, and the chunk modifiability characteristic includes secured data areas, virus targeted data areas, user prohibited data areas, fixed data areas, data area activity metric, or any combinations thereof of the target data.

12. The apparatus according to claim 9, wherein the integrity verifying comprises troubleshooting according to the subset of the chunks.

13. The apparatus according to claim 9, wherein the comparing comprising concatenating the initial and the selected chunk digest values into concatenated initial and selected chunk digest values, respectively, and comparing the concatenated initial digest value with the concatenated selected chunk digest value.

14. A computer system comprising:
a server computer in communication with a client computer,
wherein the client computer comprises
a computer controller executing
selecting data chunks of target data and obtaining digest values of the selected data chunks, based upon the target data, and
wherein the server computer comprises
a computer controller executing
comparing the digest values of the selected data chunks with corresponding maintained initial digest values of the target data, and
verifying integrity of the target data according to the comparing.

15. The computer system according to claim 14, wherein the selecting of the data chunks is based upon one or more selection parameters including data chunk size, number of data chunks, verification timing, data chunk modifiability characteristic, security information, user defined, or any combinations thereof.

16. The computer system according to claim 15, wherein the target data is a virtual machine image, and the data chunk modifiability characteristic includes secured data areas, virus targeted data areas, user prohibited data areas, fixed data areas, data area activity metric, or any combinations thereof of the target data.

17. The computer system according to claim 15,
wherein the computer server controller further executes:
dividing the target data stored on computer readable recording medium into chunks,
maintaining the initial digest values for each divided data chunk of the target data,
transmitting the target data to the client computer, and
selecting data chunks for which digest values are to be obtained and transmitting a list of selected data chunks to the client computer,
wherein the client computer obtains the digest values of the data chunks of the target data stored in the client computer, based upon the list of selected data chunks.
